(19) United States
(12) Patent Application Publication
(10) Pub. No.: US 2024/0161566 A1
(43) Pub. Date: May 16, 2024

(54) Touchless Dispensing And Communication For Machines

(71) Applicant: Trinity Axis Inc., Schwenksville, PA (US)

(72) Inventors: Jeremiah Divyan David, Tamil Nadu (IN); David D. Davidar, Schwenksville, PA (US)

(73) Assignee: Trinity Axis Inc., Schwenksville, PA (US)

(21) Appl. No.: 17/984,753

(22) Filed: Nov. 10, 2022

(51) Int. Cl. G07F 9/00; G06Q 20/20; G07F 9/02

(52) U.S. Cl. CPC G07F 9/001; G06Q 20/202; G06Q 20/203; G06Q 20/208; G07F 9/023; G07F 9/026

(57) ABSTRACT

Systems and methods of the present disclosure relate to touchless dispensing techniques. A dispensing method includes providing an optical code with a first application on a first electronic device that is in communication with a dispensing machine. The method also includes creating a unique session for a purchase of the item. The optical code is configured to be disabled during the unique session. The method further includes receiving instructions to dispense at least one item from the dispensing machine via the first application on the first electronic device and a browser or a downloadable application for another electronic device. Access to the browser or the downloadable application occurs via the optical code. The method further includes dispensing at least one selected item from the dispensing machine based on information received via the browser or the downloadable application.

### BACKGROUND

Dispensing systems may include machines to dispense a variety of items, including beverages, food, and other consumer products. However, using these systems involves peering into the machine to view the items and subsequently using buttons on the machine to make a purchase. This may be inconvenient and time consuming.

### SUMMARY

Disclosed herein are exemplary systems and methods for touchless dispensing items from vending machines. A dispensing method includes providing an optical code with a first application on a first electronic device that is in communication with a dispensing machine. The method also includes creating a unique session for a purchase of the item. The optical code is configured to disappear (or otherwise be disabled) during the unique session and regenerate upon expiration of the unique session. The method further includes receiving instructions to dispense at least one item from the dispensing machine via the first application on the first electronic device and a browser or a downloadable application for another electronic device. Access to the browser or the downloadable application occurs via the optical code. The method further includes dispensing at least one selected item from the dispensing machine based on information received via the browser or the downloadable application.

Another method includes providing an optical code with a dispensing machine and transmitting a request to an electronic device from the dispensing machine. The request includes a request to view and/or select at least one item from the dispensing machine. The transmission of the request is initiated via an optical code that is readable with the electronic device. The method also includes creating a unique session for a purchase of at least one item. The optical code is configured to disappear (or otherwise be disabled) during the unique session and regenerate upon expiration of the unique session. The method further includes dispensing at least one selected item from the dispensing machine. The dispensing machine is configured to receive instructions from the electronic device to dispense at least one selected item.

A system includes a dispensing machine and a first electronic device in communication with the dispensing machine. The first electronic device is configured to display an optical code. The optical code is configured to be disabled during a unique purchase session and regenerate upon expiration of the unique purchase session. The system further includes a browser configured to allow viewing and/or selection of at least one item in the dispensing machine, or a downloadable application configured to allow viewing and/or selection of at least one item in the dispensing machine. The browser or the downloadable application is in communication with the first electronic device.

### BRIEF DESCRIPTION OF THE DRAWINGS

These drawings illustrate certain aspects of some examples of the present disclosure and should not be used to limit or define the disclosure.

FIG. 1 illustrates a dispensing system, in accordance with examples of the present disclosure;

FIG. 2 illustrates an interior section of the dispensing system, in accordance with examples of the present disclosure;

FIG. 3 illustrates a close-up perspective view of a dispensing device, in accordance with examples of the present disclosure;

FIG. 4 illustrates an interior cross-sectional view of a dispensing device, in accordance with examples of the present disclosure;

FIG. 5 illustrates extendable members in an extended configuration, in accordance with examples of the present disclosure;

FIG. 6 illustrates a perspective view of a dispensing device, in accordance with examples of the present disclosure;

FIG. 7 illustrates a grid of dispensing passages arranged within the interior section of the dispensing system, in accordance with examples of the present disclosure;

FIG. 8 illustrates an internal structure of the dispensing system/machine, in accordance with examples of the present disclosure;

FIG. 9 illustrates an operative sequence for touchless dispensing, in accordance with examples of the present disclosure;

FIG. 10 illustrates a system for touchless dispensing, in accordance with examples of the present disclosure;

FIG. 11 illustrates another technique for touchless dispensing, in accordance with examples of the present disclosure; and

FIGS. 12A and 12B illustrate dynamic generation/regeneration of an optical code, in accordance with examples of the present disclosure.

### DETAILED DESCRIPTION

It is to be understood that the present disclosure is not limited to particular devices or methods, which may, of course, vary. It is also to be understood that the terminology used herein is for the purpose of describing particular embodiments only and is not intended to be limiting. All numbers and ranges disclosed herein may vary by some amount. Whenever a numerical range with a lower limit and an upper limit is disclosed, any number and any included range falling within the range are specifically disclosed. Although individual embodiments are discussed herein, the invention covers all combinations of all those embodiments. As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected. If there is any conflict in the usages of a word or term in this specification and one or more patent or other documents that may be incorporated herein by reference, the definitions that are consistent with this specification should be adopted for the purposes of understanding this invention.

The present disclosure relates to techniques for touchless dispensing of items from a dispensing system such as a vending machine. The techniques as described herein allow for viewing, selecting, and purchasing of at least one item via an electronic device such as, for example, a smartphone, tablet, or laptop computer.

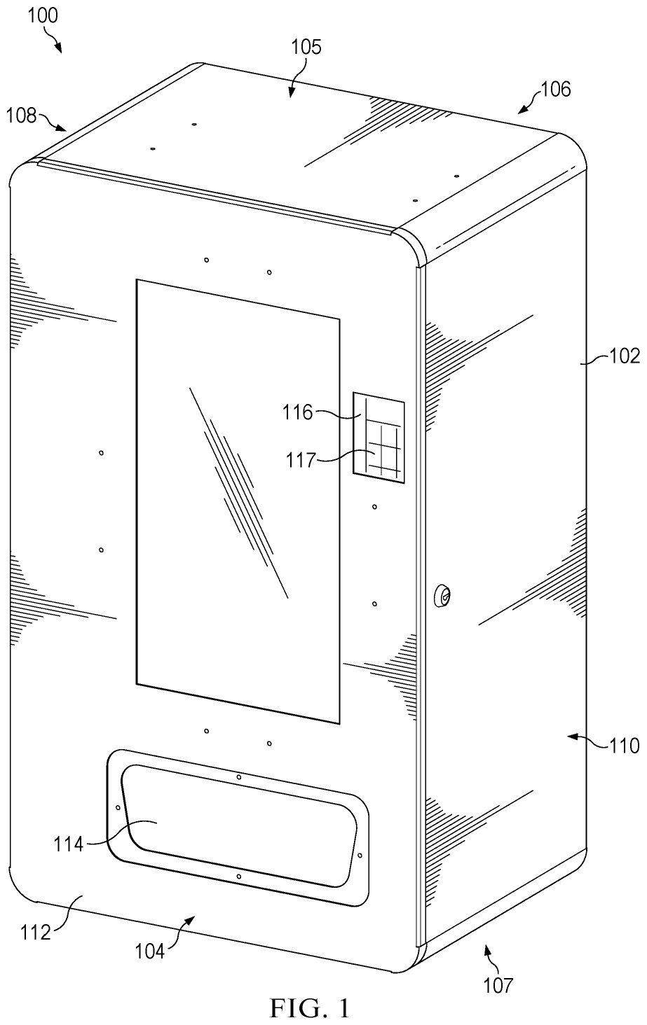

FIG. 1 illustrates a dispensing system 100, in accordance with examples of the present disclosure. The dispensing system 100 is a non-limiting example of a dispensing system. The dispensing system 100 includes a housing 102 that houses internal components (not shown) of the dispensing system 100. As illustrated, the dispensing system 100 may include a front side 104, a top side 105, a rear side 106, a bottom side 107, a left lateral side 108, and a right lateral side 110. The front side 104 may include a door 112 (e.g., a hinged door or sliding door) which may be opened to allow access to an interior of the dispensing system 100 for servicing or stocking of consumer products, for example. The door 112 may include a gate 114 for access to purchased products that have fallen in a retrieval bin that is positioned behind the gate 114. In some examples, the gate 114 may be optional to allow open access to purchased products in the retrieval bin. In some examples, the dispensing system 100 may also include a system controller 116 configured to operate the dispensing system 100. In some examples, the system controller 116 may include a payment interface or validation interface.

The system controller 116 may include a display, a storage unit, and/or any instrumentality or aggregate of instrumentalities operable to compute, estimate, classify, process, transmit, receive, retrieve, originate, switch, store, display, manifest, detect, record, reproduce, handle, validate, or utilize any form of information, intelligence, or data for business, scientific, control, or other purposes. For example, the system controller 116 may include at least one of a computer, a network storage device, RFID scanner, NFC reader, validation device or any other suitable device and may vary in size, shape, performance, functionality, and price. The system controller 116 may include a processing unit (e.g., microprocessor, central processing unit, programmable logic controller (PLC), etc.) that may process data by executing software or instructions obtained from a local non-transitory computer readable media (e.g., optical disks, magnetic disks). The non-transitory computer readable media may store software or instructions of the methods described herein. Non-transitory computer readable media may include any instrumentality or aggregation of instrumentalities that may retain data and/or instructions for a period of time. The non-transitory computer readable media may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

The system controller 116 may also include input device(s) (e.g., sensor(s), keyboard, mouse, touchpad, scanners, RFID readers, card readers, NFC readers, data reader devices, etc.) and output device(s) (e.g., monitor, printer, secondary display unit 117, etc.). The sensors may include a motion sensor (e.g., PIR), a heat sensor, and/or an input sensor. The input device(s) and output device(s) provide a user interface. For example, the system controller 116 may enable an operator to select and perform analysis, view collected data, view analysis results, and/or perform other tasks.

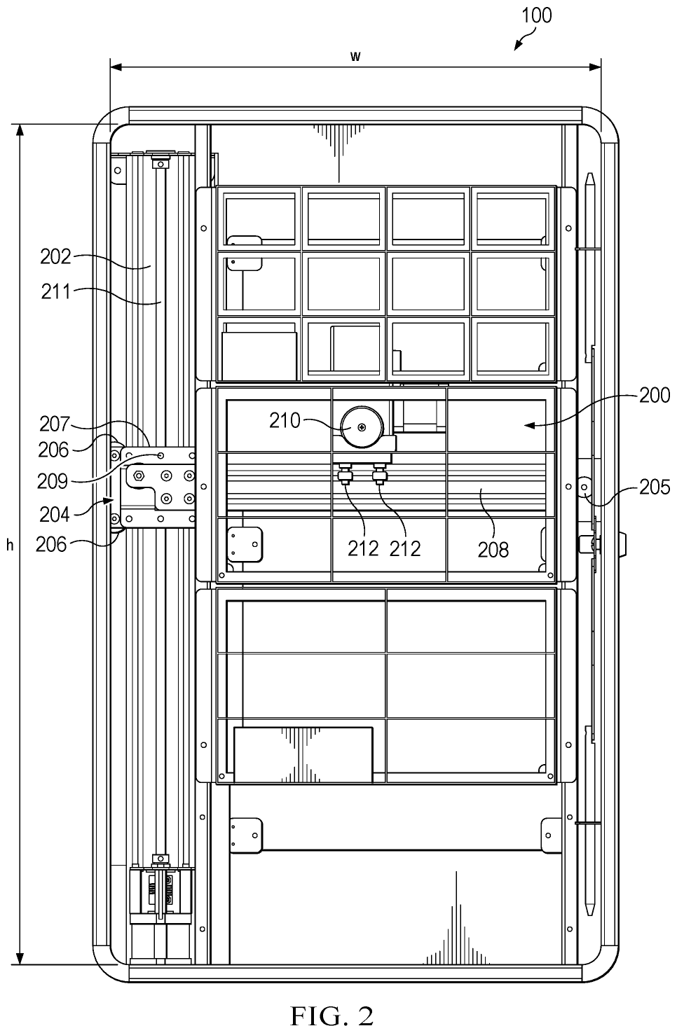

FIG. 2 illustrates a rear view of an interior section 200 of the dispensing system 100, in accordance with examples of the present disclosure. The interior section 200 may include a vertical rail 202 extending along a height h of a rear of the interior section 200 of the dispensing system 100. The vertical rail 202 may be coupled or fixed to the interior section 200 with any suitable technique and may remain stationary. Suitable techniques for coupling of fixing the vertical rail 202 to the interior section 200 may include, but are not limited to, bolts, threads, or welds, for example.

In some examples, a movable structure 204 may include at least two rollers 206 and/or a nut block 207, each movably disposed on the vertical rail 202. In some examples, the nut block 207 may include a structure configured to move along the vertical rail 202 via a lead member 209 (e.g., a screw) that may extend into the rail 202 such as within a lead screw 211. The nut block 207 may move along the vertical rail 202 by any suitable means such as conveyor system and/or gears disposed within (or adjacent to) the vertical rail 202. In some examples, the vertical rail 202 may be configured as a linear track allowing the movable structure 204 to move vertically along the vertical rail 202. Other suitable techniques for facilitating movement of the moveable structure 204 on vertical rail 202 may be used such as a motor 205.

A lateral rail 208 may extend from the movable structure 204. The lateral rail 208 may extend laterally across a width w of the interior section 200 of the dispensing system 100, in some examples. The lateral rail 208 may move vertically along the vertical rail 202 via the movable structure 204. It should be noted that other suitable mechanisms may be utilized for vertical movement within the interior section 200 of the dispensing system 100, as should be understood by one having skill in the art with the benefit of this disclosure.

A dispensing device 210 may be movably disposed on the lateral rail 208. The dispensing device 210 may include rollers 212 that may contact the lateral rail 208. The dispensing device 210 may be configured to move laterally along the lateral rail 208.

The rollers 212 may be any suitable rollers for facilitating movement of the dispensing device 210 along the lateral rail 208. For example, the rollers 212 may be moved along the lateral rail 208 by a belt and pulley mechanism, and the lateral rail 208 may be configured as a linear track allowing the dispensing device 210 to move laterally along the lateral rail 208. It should be noted that other suitable mechanisms may be utilized for lateral movement within the interior section 200 of the dispensing system 100, as should be understood by one having skill in the art with the benefit of this disclosure such as for example a motor.

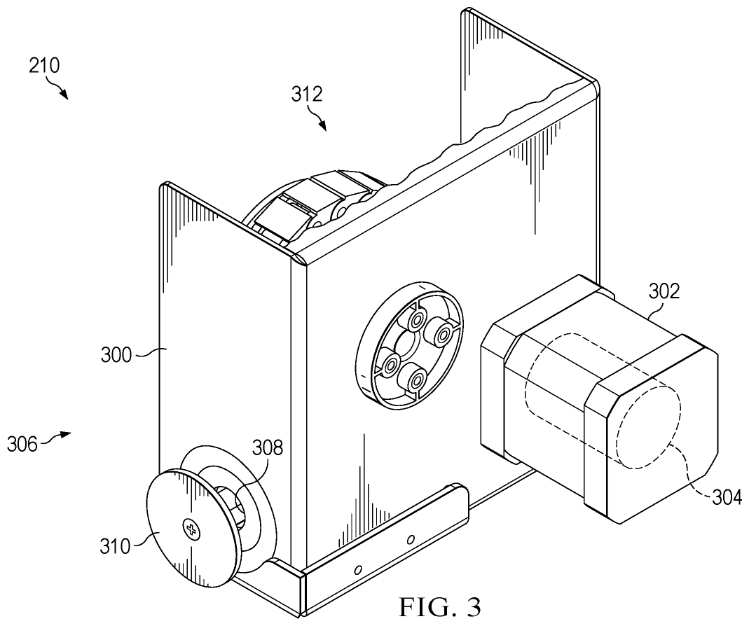

FIG. 3 illustrates a close-up perspective view of the dispensing device 210, in accordance with examples of the present disclosure. The dispensing device 210 may include a housing 300. The housing 300 may be of any suitable shape such as rectangular, for example. A second housing 302 may be disposed adjacent to the housing 300. The second housing may also be of any suitable shape such as a rectangle, for example. The second housing 302 may contain an electric motor 304 which may be powered by any suitable means such as wires and an electric grid or a battery, for example.

An interior of the housing 300 may be in fluid communication with an interior of the second housing 302 to allow operation of the motor 304, for example. A front portion 306 of the housing 300 may include an aperture 308 which may allow at least one extendable member 310 to extend away from the housing 300. The member 310 may extend from an interior portion 312 of the housing 300 during dispensing of an item, or the member 310 may retract into the interior portion 312 after the dispensing.

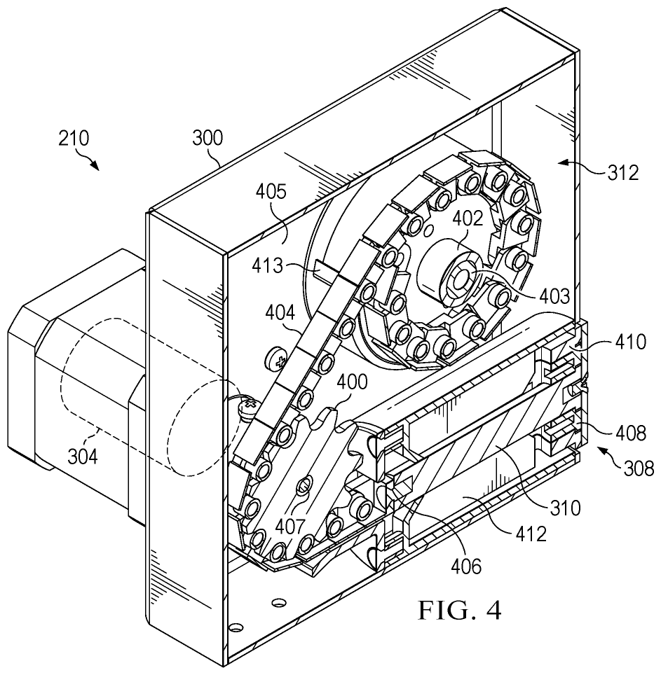

FIG. 4 illustrates the interior portion 312 of the housing 300 of the dispensing device 210, in accordance with examples of the present disclosure. As illustrated, the housing 300 may contain a movable member (e.g., a sprocket 400), a spool 402, and member 404 (e.g., a chain). The motor 304 may be operatively coupled (e.g., via a shaft or direct coupling) to the movable member such as a sprocket 400 that may be rotatably disposed within the interior portion 312. The sprocket 400 may be adjacent to the spool 402. In some examples, the spool 402 may be configured to rotate. The sprocket 400 and the spool 402 may each be rotatably coupled to an inner surface of the interior portion 312. The sprocket 400, spool 402 and member 404 may be configured as a linear actuator. The spool 402 may rotate back to the coiled position by the assistance of a spring 413 that may be disposed adjacent to the spool 402 such as between an inner wall 405 of the housing 300 and the spool 402, for example. It should be noted that this configuration is a non-limiting example and other suitable linear actuators may be utilized for conversion of rotational movement of the motor 304 to linear movement, as should be understood by one having skill in the art with the benefit of this disclosure.

For example, a pin 403 may rotatably couple the spool 402 to the inner wall 405; and a shaft 407 may extend from the sprocket 400 through the inner wall 405 and to the motor 304. A member 404 may extend from the spool 402 to the sprocket 400 and may operatively couple the sprocket 400 to the spool 402. The member 404 may be configured to transfer rotational movement of the sprocket 400 to the extendable member 310. In some examples, the member 404 may include a chain that may be at least partially wound around the spool 402 and the sprocket 400. A distal end 406 of the member 404 may be coupled to at least one extendable member 310 configured to pass through the aperture 308. While member 404 is illustrated on FIG. 4 as a chain, other suitable devices may be used for transferring motion of the sprocket 400 to the extendable member 310, including, but not limited to, a belt.

In some examples, a plurality of extendable members may be disposed concentrically within the interior portion 312 of the dispensing device 210. For example, the extendable member 310 may be disposed within extendable members 408 and 410. The extendable members 310, 408, and 410 may be disposed within a base 412 in a telescopic or concentric configuration. In other examples, the extendable members 310, 408, and 410 may be aligned eccentrically. The base 412 may be coupled to the interior portion 312 of the housing 300, such as to the inner wall 405, for example. The base 412 may be coupled to the interior portion 312 of the housing 300 via any suitable means such as fasteners including threads, welds, or pins, for example. As illustrated, the extendable members 310, 408, and 410 are in a retracted configuration; during dispensing, the extendable members 310, 408, and 410 may extend in a telescopic fashion, for example. It should be noted that the telescopic configuration is a non-limiting example and that other suitable techniques for extension may be utilized, as should be understood by one having skill in the art, with the benefit of this disclosure. Examples of other techniques that could be used instead of telescopic members may include rack & pinion technique.

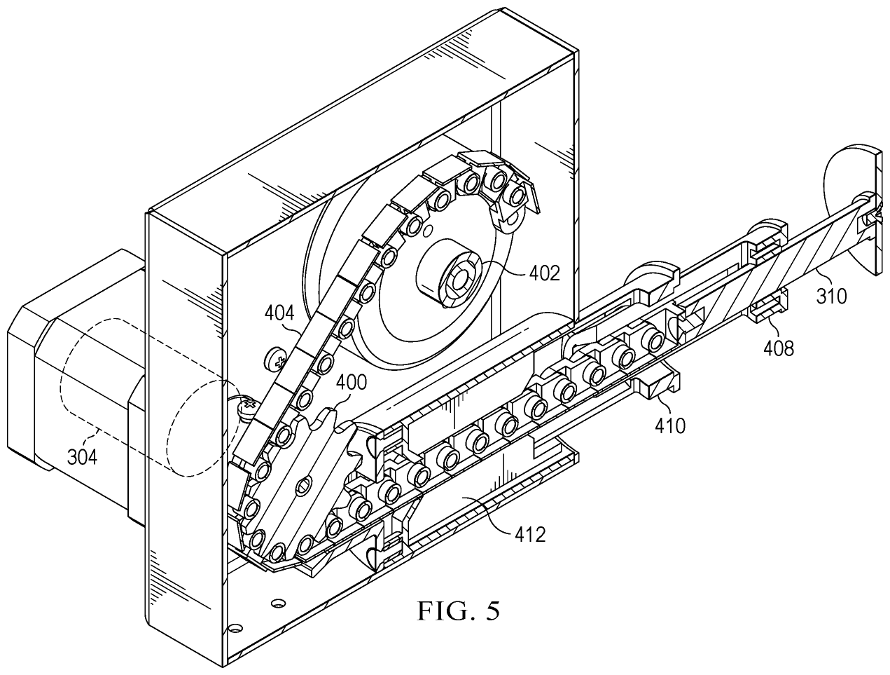

FIG. 5 illustrates the extendable members 310, 408, and 410 in an extended configuration, in accordance with examples of the present disclosure. The extendable members 310, 408, and 410 may extend from the base 412 upon rotation of sprocket 400 by the motor 304. The rotation of the sprocket 400 may cause rotation of the spool 402 thereby causing at least partial unravelling of the member 404 from around the spool 402, thereby causing extension of the extendable members 310, 408, and 410. In some examples, the extendable members 310, 408, and 410 may extend from the base 412 telescopically, as shown. Each of the extendable members 310, 408, 410, and the base 412 may have outer diameters (OD) and inner diameters (ID) that are configured to allow retraction and extension in a telescopic fashion.

For example, an OD of the member 310 may be less than an ID of the member 408; an OD of the member 408 may be less than an ID of the member 410; and an OD of the member 410 may be less than an ID of the base 412. Each of the extendable members 310, 408, 410, and the base 412 may be hollow to allow for passage of the member 404 therethrough during extension and retraction. In some examples, the extendable members 310, 408, 410, and the base 412 may be tubular, however, any suitable shape may be utilized as should be understood by one having skill in the art with the benefit of this disclosure.

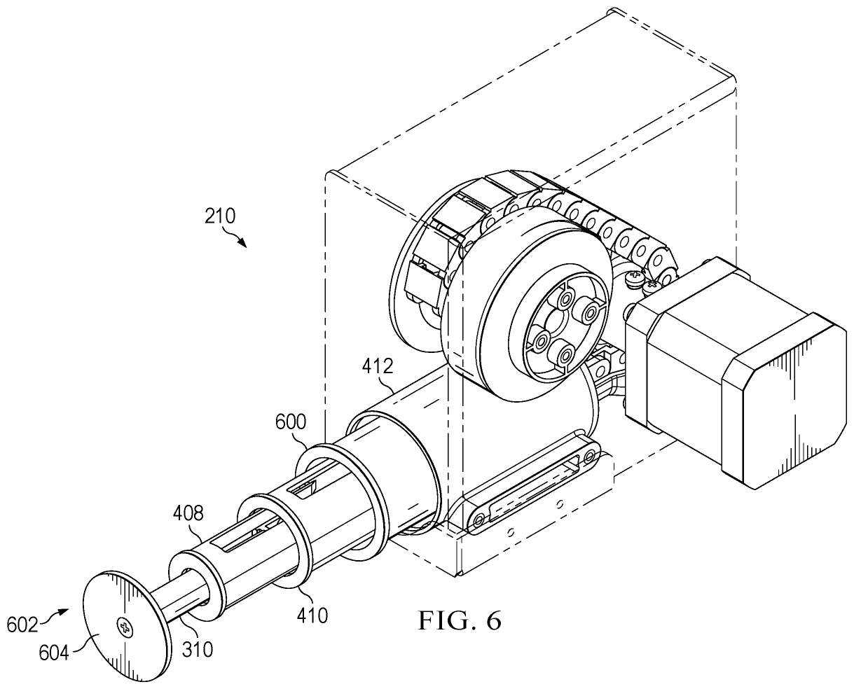

FIG. 6 illustrates a perspective view of the dispensing device 210, in accordance with examples of the present disclosure. In some examples, the dispensing device 210 may include the extendable members 310, 408, 410, and an additional extendable member 600 that may extend from the base 412 in a telescopic or concentric configuration. The extendable members 310, 408, 410, and 600 may be hollow to allow for passage of the member 404, as shown on FIG. 5.

In certain examples, the extendable member 310 may include a distal end 602 with a flat surface 604 to facilitate contacting and pushing items forward. It should be noted that the shapes and sizes for the extendable members 310, 408, 410, and 600 may be of any suitable shape. For example, the extendable members 310, 408, 410, and 600 may be of a cylindrical, box-type, prism, or rectangular shape.

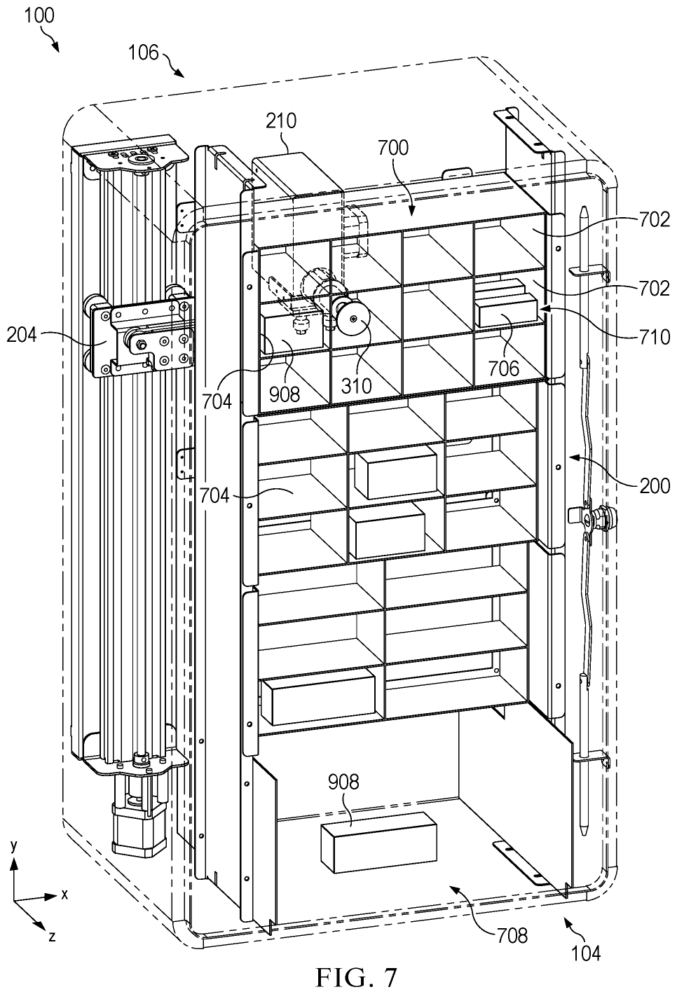

FIG. 7 illustrates a grid 700 of dispensing passages 702 arranged within the interior section 200 of the dispensing system 100, in accordance with examples of the present disclosure. The dispensing passages 702 may include through-holes 704 extending horizontally from the rear side 106 of the dispensing system 100 to the front side 104 of the dispensing system 100. An item 706 such as a consumer product may be stocked or stacked within a dispensing passage 702. During dispensing, the movable structure 204 and the dispensing device 210 may move to align with the item 706 along the x-axis and the y-axis. Upon alignment, the dispensing device 210 may extend at least the extendable member 310 along the z-axis to push the item 706 such that the item 706 falls into a retrieval bin 708 for retrieval by a consumer. In some examples, a horizontal stack 710 of items 706 may be disposed within each dispensing passage 702. As items are dispensed, the horizontal stack 710 becomes shorter. In certain examples, the display unit 117 may include a touch screen display that may include a user interface to select or have access to the locations of items 706. In some examples, the system controller 116 may store a map or have access to the locations of the items 706.

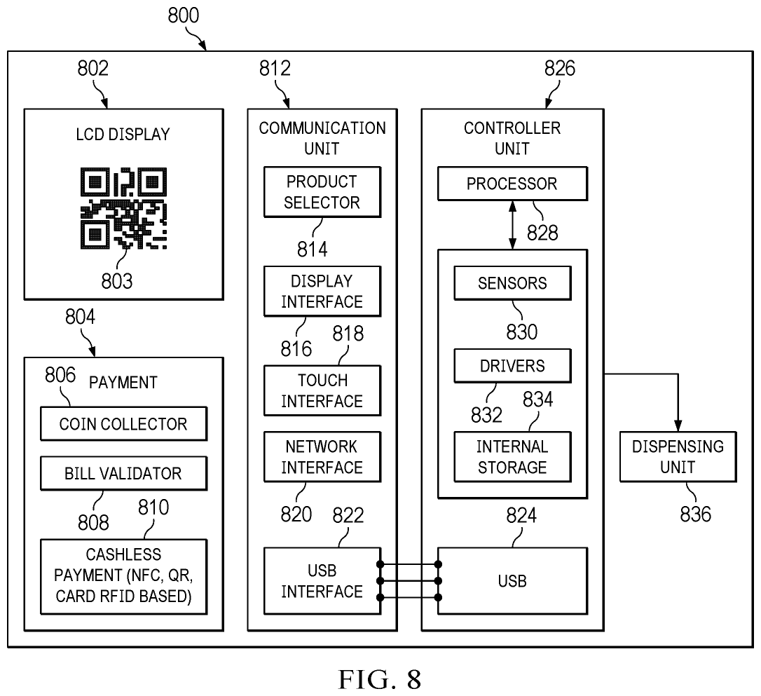

FIG. 8 illustrates an internal structure 800 of dispensing system/machine, in accordance with examples of the present disclosure. The internal structure 800 may include an LCD display 802 (e.g., a touchscreen) that may display a scannable/optical code 803 such as a QR code (QR), 3D code, and/or a bar code, for example. A payment system 804 may also be included such as for example, a coin collector 806, a bill validator 808, and/or a cashless payment system 810 (e.g., RFID, NFC, QR, card based). In some examples, the LCD display 802 may be a separate device (e.g., monitor, TV) from the dispensing machine and may be in communication with the dispensing machine.

The structure 800 also includes a communication unit 812 that includes a product selector 814 (e.g., button), a display interface 816, a touch interface 818, a network interface 820 including: wireless, SIM, and/or ethernet based communications. A USB interface 822 may be coupled to a USB unit 824 of a controller unit 826. The controller unit 826 includes a processor 828 that is in communication with sensors 830 (e.g., motion sensors for movement of items to be dispensed, contact sensors, weight sensors, optical sensors, and/or limit switches), drivers 832, and/or internal storage 834 for completing a touchless dispensing transaction. A dispensing unit 836 may receive instructions from the controller unit 826 for dispensing at least one purchased/selected item.

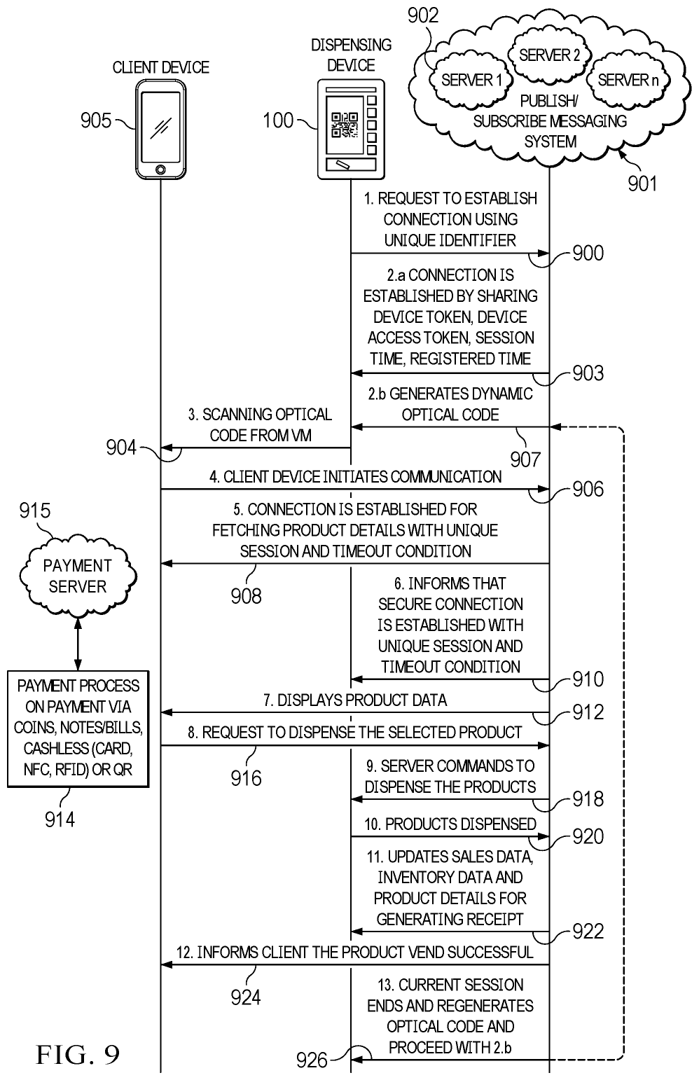

FIG. 9 illustrates an operative sequence for touchless dispensing, in accordance with examples of the present disclosure. At step 900, the dispensing system 100 requests to establish a connection with a network 901 via a unique identifier (e.g., an anonymized string of characters generated for a device upon initial setup). The network 901 may include at least one server 902 (e.g., network server). At step 903, the connection is established via sharing a dynamically generated optical code encrypted with a device token, device details, access token, session time, and registered time. The dynamically generated optical code refreshes periodically.

At step 904, a client device such as for example, an electronic device 905 (e.g., a smartphone, portable electronic device, or portable computer) may scan the dynamically generated optical code of steps 907 and 903 that may be generated with the dispensing system 100 (e.g., a vending machine). At step 906, the portable electronic device 905 initiates communication with the network 901 using a device access token. At step 908, a connection between the network 901 and the portable electronic device 905 is established for fetching/retrieving details of items for dispensing, according to a unique session and a timeout condition (e.g., period of time until timeout).

At step 910, the network 901 informs the dispensing device 100 that a secure connection is established with the unique session and the timeout condition. At step 912, the portable electronic device 905 displays data/detail(s) of the product(s) received from the network 901. At step 914, payment for at least one selected product/item occurs via various methods (e.g., at least one of coins, notes/bills, cashless (card, NFC, RFID), or QR). For example, a payment server 915 (e.g., network server) may be employed at step 914 to process payment. Upon successful completion of payment, at step 916, the portable electronic device 905 requests/instructs the network 901 to dispense the selected item/product. At step 918, the network 901 commands the dispensing system 100 to dispense the selected product/item.

At step 920, the dispensing system 100 dispenses the selected product. At step 922, the network 901 updates the sales data, inventory data, and product/item details for generating a sales receipt (e.g., electronic receipt) at the dispensing system 100. At step 924, the network 901 informs the portable electronic device 905 of a successful/completed dispensing of an item upon purchase. At step 926, the current purchase/vending session expires and a new optical code is generated per step 907 and the sequence may be repeated.

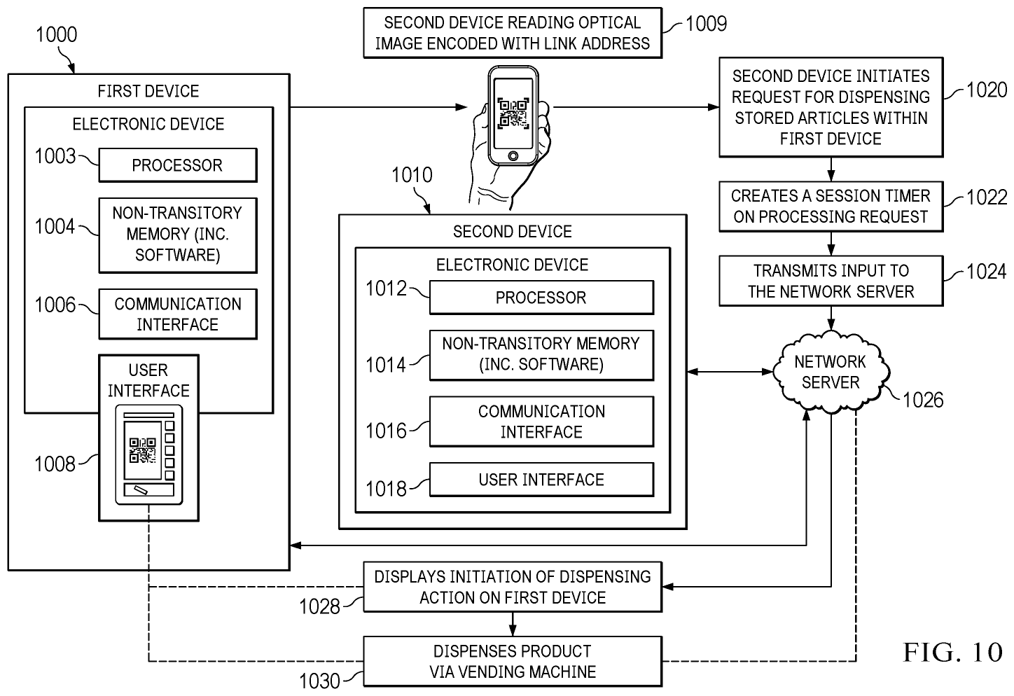

FIG. 10 illustrates a system for touchless dispensing, in accordance with examples of the present disclosure. A first electronic device 1000 may include a dispensing machine, a processor 1003, non-transitory memory 1004 (e.g., software), a communication interface 1006, and a user interface 1008 that includes a display such as a touchscreen, for example.

At step 1009, the first electronic device 1000 provides/displays an optical image (e.g., QR, 3D code, and any scannable code) that may be read by the second electronic device 1010. In some examples, readers/scanners for the optical code/image may include electronic devices with cameras (e.g., smartphone, laptop, tablet). The optical image may include a link address (e.g., website). The second electronic device 1010 may include a processor 1012, non-transitory memory 1014, a communication interface 1016, and a user interface 1018. At step 1020, the second electronic device 1010 initiates a request to the first electronic device 1000 via the network server 1026 for dispensing items from the first electronic device 1000. For example, the request includes a request to view and/or select at least one item from the dispensing machine. Transmission of the request is initiated via the optical image/code that is readable with the second electronic device 1010.

At step 1022, the second electronic device 1010 creates a session timer for processing the request from the first electronic device 1000 for dispensing item(s) from the first electronic device 1000. In some examples, disabling the user interface 1008 of the first electronic device 1000 from allowing any further requests until a dispensing action has occurred via the second electronic device input or a pre-defined session has timed out.

At step 1024, information (e.g., selected items, purchase info) is transmitted to a network server 1026. At step 1028, the first electronic device 1000 displays initiation of a dispensing action and at step 1030, the product/item is dispensed. Databases of sales inventory are updated based on completed actions performed either by the first electronic device 1000 or the second electronic device 1010 or both.

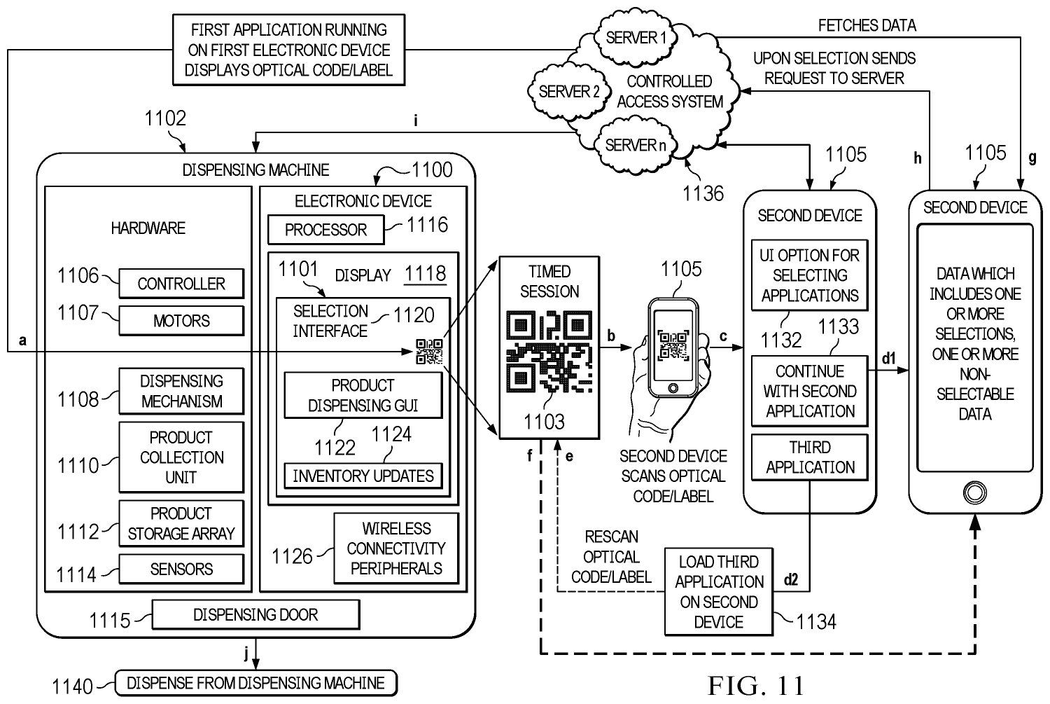

FIG. 11 illustrates another system for touchless dispensing, in accordance with examples of the present disclosure. At step (a), a first software application of the first electronic device 1100 fetches, via server connectivity, an optical code/label to be displayed on the first electronic device 1100. The first electronic device 1100 runs the first software application that displays an optical label/code (QR) during a timed session (e.g., 1 second to 2 minutes). The first electronic device 1100 is in communication (e.g., sends signals/code for processing selections) with a dispensing machine 1102 (e.g., vending machine).

The first software application may operate the dispensing machine 1102 via a server 1136 (e.g., network). The first software application may display an optical code 1103 via the server 1136 and receive/send instructions from/to a second/third software application that is on a second electronic device 1105 via the server 1136. In some examples, the first software application also updates sales and inventory data. The first electronic device 1100 may include a computer and a display and is configured to transmit wireless signals to the dispensing machine 1102 and receive wireless signals from the second electronic device 1105. The first electronic device 1100 may be integrated into the dispensing machine 1102.

The dispensing machine 1102 includes a controller 1106, motors 1107, dispensing mechanism 1108, a product collection unit 1110, product storage array 1112, sensors 1114, and a dispensing door 1115. The first electronic device 1100 includes a processor 1116, a display 1118 with a selection interface 1120, a product dispensing GUI 1122, inventory updates 1124, and wireless connectivity peripherals 1126.

At step (b), scanning of the optical code/label using the second device occurs. At step (c), based on the data of the optical code, fetching (from at least one server) details to be displayed on a second application on the second device, occurs. The data may include visual representations of multiple options. The data includes one or more selections, one or more non-selectable data to be displayed on the second electronic device 1105. A second software application on the second electronic device 1105 is initiated/opened based on a scan of the optical code 1103 with the second electronic device 1105. The second electronic device 1105 includes client device(s), electronic device(s), wearable device(s), smartphone(s), and/or computer device(s). After scanning of the optical code 1103, the user interface of the second electronic device 1105 displays/allows an option for selecting a third software application (e.g., downloadable software from software app store), or continuing on the second software application (e.g., browser) via communicating data with the server 1136. The second electronic device 1105 provides a graphical representation 1132 for displaying options. At step 1133, a selection to continue with the second application may occur. Continuing on the second software application occurs at step (d1). A timed session is triggered with data fetched from the server and loaded on a second application on the second electronic device 1105. Both the second and third software applications allow viewing, selection, and purchasing of items that are in the dispensing machine.

At step (d2), the third software application may be loaded onto the second electronic device 1105. The third application may be loaded onto the second electronic device at step 1134. For example, if the option for opening the third software application is selected, loading the third software application onto the second electronic device 1105 occurs. The second software application may include a browser. The third software application may include a software application downloaded from a software application store. Selections are transmitted from the second/third software application to the first software application of the first electronic device 1100 via at least one server 1136.

At step (e), rescanning of the optical code 1103 may occur. A timed session (f) may be initiated/triggered upon performing step (g) which includes fetching data from at least one server 1136 and loading the data on the third application on the second electronic device 1105. The data includes one or more selections, one or more non-selectable data to be displayed on the second electronic device 1105.

At step (h), the second electronic device 1105 sends the selections to the server 1136 upon at least one selection occurring on the second/third application on the second electronic device 1105. At step (i), the first electronic device 1100 receives the signal from the server 1136 and processes the code 1103. At step (j), the dispensing machine 1102 dispenses one or more selected products/items. The GUI (graphical user interface) of the first electronic device 1100 shows that the product is dispensing. After the dispensing machine 1102 completes the dispensing process, the GUI of the first software application reflects updated inventory.

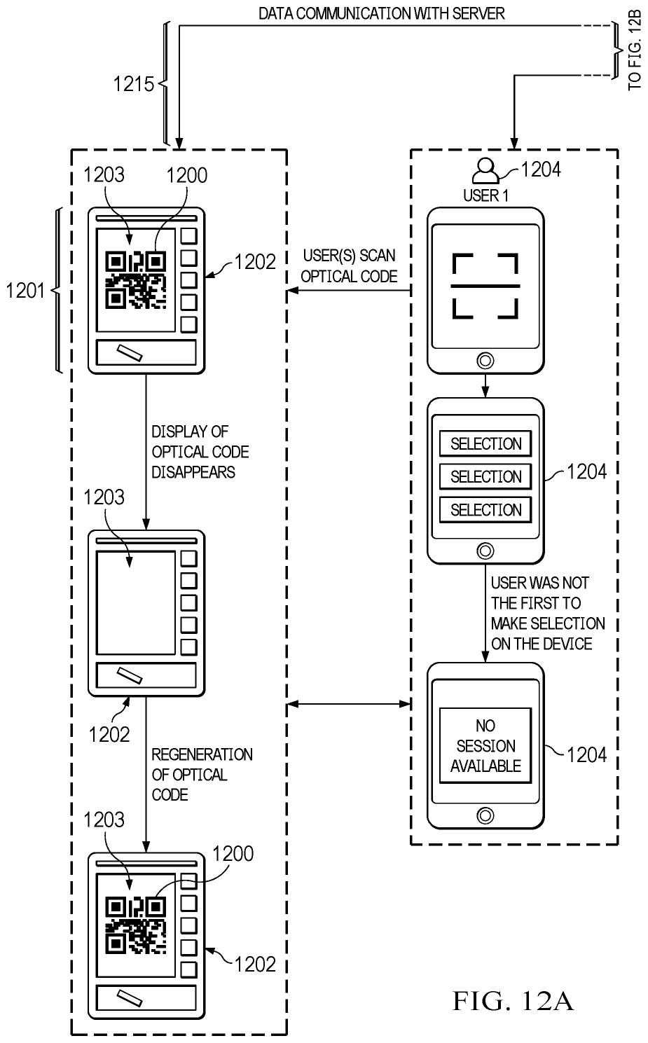

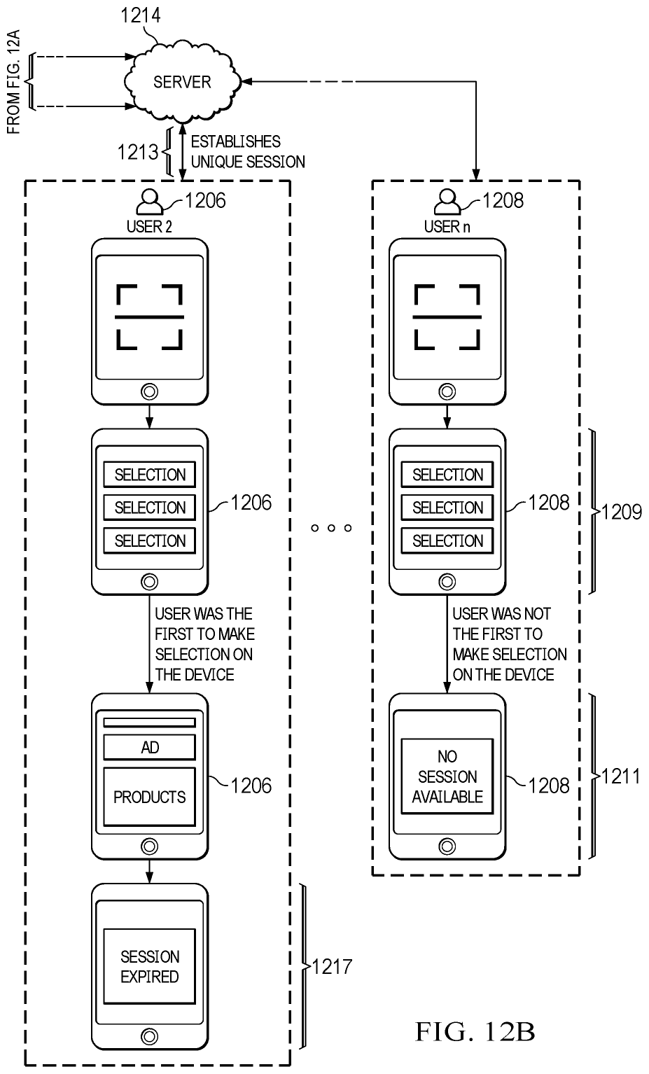

FIGS. 12A and 12B illustrate dynamic generation/regeneration of an optical code, in accordance with examples of the present disclosure. At stage 1201, an optical code 1200 is fetched from a network server 1214 and displayed (a display 1203) by a dispensing machine 1202. A first electronic device 1204 (e.g., first user), a second electronic device 1206 (e.g., second user), and a third electronic device 1208 (e.g., third user) may be in the vicinity for scanning of the optical code 1200. Each of the devices scan the optical code 1200. Although three users are illustrated, it should be noted that any number of users may initially communicate (e.g., scan the optical code) with the dispensing machine 1202 within the network server 1214.

At stage 1209, after scanning of the optical code, based on data communication with network server 1214, each of the users is prompted by the respective device to select an option for interacting with the dispensing machine 1202 (e.g., view multiple selectable and non-selectable data for the dispensing machine 1202). At stage 1211, the second device 1206 is the first device to receive a selection/input from the second user. The devices 1204 and 1208 (e.g., an end user) did not receive a selection first and therefore no session is available for these devices and these devices display/indicate to the respective users that a session is not available for purchasing items from the dispensing machine 1202. The device 1206 displays a response to the user's selection (e.g., showing ads and/or products/items).

At stage 1213, a unique session is established between the network server 1214 and the device 1206. During the session, the device 1206 and the network server 1214 communicate data (e.g., data including items for purchase/selections) with each other. At stage 1215, the network server 1214 and the dispensing machine 1202 communicate the data with each other. The data communication therebetween includes pre-configured actions such as a predetermined timed session which may include a session from 1 to 5 minutes, for example. A preconfigured action may also include a single purchase session with a max time limit. These pre-configured actions are configured on at least one network server. The optical code is disabled (e.g., disappears from the display 1203 of the dispensing machine 1202) during the established unique session. At stage 1217, if the user session has expired, the network server 1214 generates the optical code 1200 which will be sent to the dispensing machine 1202 to be displayed on the display 1203. Otherwise, the established unique session remains/continues until expiration.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

What is claimed is:

1. A method comprising:
providing an optical code with a dispensing machine;
transmitting a request to an electronic device from the dispensing machine, wherein the request includes a request to view and/or select at least one item from the dispensing machine, wherein transmission of the request is initiated via an optical code that is readable with the electronic device;
creating a unique session for a purchase of at least one item, the optical code configured to be disabled during the unique session and regenerate upon expiration of the unique session; and
dispensing at least one selected item from the dispensing machine, the dispensing machine configured to receive instructions from the electronic device to dispense the selected item.

2. The method of claim 1, further comprising creating a timed session for dispensing an item from the dispensing machine.

3. The method of claim 1, further comprising displaying initiation of a dispensing action on the electronic device.

4. The method of claim 1, wherein the optical code is displayed on the dispensing machine.

5. The method of claim 1, further comprising updating inventory data and sales data.

6. The method of claim 1, wherein the dispensing machine includes a vending machine.

7. The method of claim 1, wherein the dispensing machine is configured to receive instructions from a network that is in communication with the electronic device.

8. A method comprising:
providing an optical code with a first application on a first electronic device that is in communication with a dispensing machine;
receiving instructions to dispense at least one item from the dispensing machine via the first application on the first electronic device and a browser or a downloadable application for another electronic device, wherein access to the browser or the downloadable application occurs via the optical code;
creating a unique session for a purchase of at least one item, the optical code configured to be disabled during the unique session and regenerate upon expiration of the unique session; and
dispensing at least one selected item from the dispensing machine based on information received from the browser or the downloadable application.

9. The method of claim 8, further generating a receipt for the selected item.

10. The method of claim 8, wherein a network server transmits the information from the browser to the first electronic device.

11. The method of claim 10, wherein the information includes selection information.

12. The method of claim 8, wherein a network server transmits the information from the downloadable application to the first electronic device.

13. The method of claim 12, wherein the information includes selection information.

14. The method of claim 8, further comprising sending dispensing instructions to the dispensing machine with the first electronic device based on at least one selection made with the browser.

15. The method of claim 8, further comprising sending dispensing instructions to the dispensing machine with the first electronic device based on at least one selection made with the downloadable application.

16. A system comprising:
a dispensing machine;
a first electronic device in communication with the dispensing machine, the first electronic device configured to display an optical code, the optical code configured to be disabled during a unique purchase session and regenerate upon expiration of the unique purchase session; and
a browser configured to allow viewing and/or selection of at least one item in the dispensing machine or a downloadable application configured to allow viewing and/or selection of at least one item in the dispensing machine, wherein the browser or the downloadable application is in communication with the first electronic device.

17. The system of claim 16, wherein the optical code includes a QR code.

18. The system of claim 16, wherein the dispensing machine includes a vending machine.

19. The system of claim 16, wherein the browser is configured for operation on another electronic device.

20. The system of claim 16, wherein the downloadable application is configured for operation on another electronic device.
